(19) United States
(12) Patent Application Publication
(10) Pub. No.: US 2009/0284524 A1
(43) Pub. Date: Nov. 19, 2009

(54) Optimized Graphical Calculation Performance by Removing Divide Requirements

(76) Inventors: Robert Allen Shearer, Rochester, MN (US); Alfred Thomas Watson, III, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/120,522

(22) Filed: May 14, 2008

(51) Int. Cl. G06T 15/00

(52) U.S. Cl. 345/419

(57) ABSTRACT

By employing a scaled method for calculating the intersection of a ray with two bounding planes, divide operations may be avoided, which may result in fewer clock cycles and, possibly simplified processing logic.

### BACKGROUND OF THE INVENTION

1. Field of the Invention

The present invention is generally related to the field of image processing, and more specifically to vector units for supporting image processing.

2. Description of the Related Art

Image processing involves performing both, vector and scalar operations. Vector operations include performing operations on one or more vectors, such as, for example, dot product operations and cross product operations. Scalar operations include addition, subtraction, multiplication, division, and the like. Accordingly, processors that process images include an independent vector unit for performing vector operations and an independent scalar unit for performing scalar operations.

Each of the vector and scalar units typically has their own respective register file. The register file contains data operated on by the associated vector or scalar unit. The register file is also used to store results of operations performed by the respective vector or scalar unit. If results of one unit are needed for an operation performed by the other unit, the results must be stored to memory first, and then loaded into the respective register file of the other unit.

### SUMMARY OF THE INVENTION

One embodiment of the present invention provides a method for performing an intersection test for a ray and a bounding volume. The method generally includes calculating a set of scaling factors based on the x, y and z component values of a direction vector defining the ray and utilizing the scaling factors to perform the intersection test without division operations.

Another embodiment of the present invention provides a processor capable of performing intersection tests for a ray and a bounding volume. The processor generally includes logic for calculating a set of scaling factors based on the x, y and z component values of a direction vector defining the ray and logic for utilizing the scaling factors to perform the intersection test without division operations.

Another embodiment of the present inventions provides a system, configured to perform an intersection test for a ray and a bounding volume. The system generally includes logic for calculating a set of scaling factors based on the x, y and z component values of a direction vector defining the ray and logic for utilizing the scaling factors to perform the intersection test without division operations.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a multiple core processing element, according to one embodiment of the invention.

FIG. 2 illustrates a multiple core processing element network, according to an embodiment of the invention.

FIG. 3 is an exemplary three-dimensional scene to be rendered by an image processing system, according to one embodiment of the invention.

FIG. 4 illustrates a detailed view of an object to be rendered on a screen, according to an embodiment of the invention.

FIG. 5 illustrates the necessary calculations for a non-scaled and scaled ray-volume intersection test.

FIG. 6 illustrates method for performing a ray-volume intersection test.

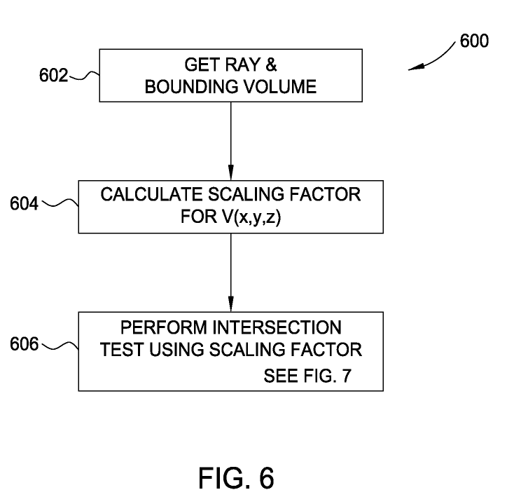

FIG. 7 illustrate the flow of calculations performed in a ray-volume intersection test.

FIGS. 8A & 8B are block diagrams illustrating the calculations performed according to an embodiment of the invention.

### DETAILED DESCRIPTION OF THE PREFERRED EMBODIMENTS

Embodiments of the invention are generally related to image processing, and more specifically to vector units and register files for supporting image processing. A combined vector/scalar unit is provided wherein one or more processing lanes of the vector unit are used for performing scalar operations. An integrated register file is also provided for storing vector and scalar data. Therefore, the transfer of data to memory to exchange data between independent vector and scalar units is obviated.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

Embodiments of the invention may be utilized with and are described below with respect to a system, e.g., a computer system. As used herein, a system may include any system utilizing a processor and a cache memory, including a personal computer, internet appliance, digital media appliance, portable digital assistant (PDA), portable music/video player and video game console. While cache memories may be located on the same die as the processor which utilizes the cache memory, in some cases, the processor and cache memories may be located on different dies (e.g., separate chips within separate modules or separate chips within a single module).

### Image Processing

The process of rendering two-dimensional images from three-dimensional scenes is commonly referred to as image processing. A particular goal of image processing is to make two-dimensional simulations or renditions of three-dimensional scenes as realistic as possible. This quest for rendering more realistic scenes has resulted in an increasing complexity of images and innovative methods for processing the complex images.

Two-dimensional images representing a three-dimensional scene are typically displayed on a monitor or some type of display screen. Modern monitors display images through the use of pixels. A pixel is the smallest area of space which can be illuminated on a monitor. Most modern computer monitors use a combination of hundreds of thousands or millions of pixels to compose the entire display or rendered scene. The individual pixels are arranged in a grid pattern and collectively cover the entire viewing area of the monitor. Each individual pixel may be illuminated to render a final picture for viewing.

One method for rendering a real world three-dimensional scene onto a two-dimensional monitor using pixels is called rasterization. Rasterization is the process of taking a two-dimensional image represented in vector format (mathematical representations of geometric objects within a scene) and converting the image into individual pixels for display on the monitor. Rasterization is effective at rendering graphics quickly and using relatively low amounts of computational power; however, rasterization suffers from some drawbacks. For example, rasterization often suffers from a lack of realism because it is not based on the physical properties of light, rather rasterization is based on the shape of three-dimensional geometric objects in a scene projected onto a two-dimensional plane. Furthermore, the computational power required to render a scene with rasterization scales directly with an increase in the complexity of objects in the scene to be rendered. As image processing becomes more realistic, rendered scenes become more complex. Therefore, rasterization suffers as image processing evolves, because rasterization scales directly with complexity.

Another method for rendering a real world three-dimensional scene onto a two-dimensional monitor using pixels is called ray tracing. The ray tracing technique traces the propagation of imaginary rays, which behave similar to rays of light, into a three-dimensional scene which is to be rendered onto a computer screen. The rays originate from the eye(s) of a viewer sitting behind the computer screen and traverse through pixels, which make up the computer screen, towards the three-dimensional scene. Each traced ray proceeds into the scene and may intersect with objects within the scene. If a ray intersects an object within the scene, properties of the object and several other contributing factors, for example, the effect of light sources, are used to calculate the amount of color and light, or lack thereof, the ray is exposed to. These calculations are then used to determine the final color of the pixel through which the traced ray passed.

The process of tracing rays is carried out many times for a single scene. For example, a single ray may be traced for each pixel in the display. Once a sufficient number of rays have been traced to determine the color of all of the pixels which make up the two-dimensional display of the computer screen, the two-dimensional synthesis of the three-dimensional scene can be displayed on the computer screen to the viewer.

Ray tracing typically renders real world three-dimensional scenes with more realism than rasterization. This is partially due to the fact that ray tracing simulates how light travels and behaves in a real world environment, rather than simply projecting a three-dimensional shape onto a two-dimensional plane as is done with rasterization. Therefore, graphics rendered using ray tracing more accurately depict on a monitor what our eyes are accustomed to seeing in the real world.

Furthermore, ray tracing also handles increasing scene complexity better than rasterization. Ray tracing scales logarithmically with scene complexity. This is due to the fact that the same number of rays may be cast into a scene, even if the scene becomes more complex. Therefore, ray tracing does not suffer in terms of computational power requirements as scenes become more complex unlike rasterization.

Ray tracing generally requires a large number of floating point calculations, and thus increased processing power, required to render scenes. This may particularly be true when fast rendering is needed, for example, when an image processing system is to render graphics for animation purposes such as in a game console. Due to the increased computational requirements for ray tracing it is difficult to render animation quickly enough to seem realistic (realistic animation is approximately twenty to twenty-four frames per second).

Image processing using, for example, ray tracing, may involve performing both vector and scalar math. Accordingly, hardware support for image processing may include vector and scalar units configured to perform a wide variety of calculations. The vector and scalar operations, for example, may trace the path of light through a scene, or move objects within a three-dimensional scene. A vector unit may perform operations, for example, dot products and cross products, on vectors related to the objects in the scene. A scalar unit may perform arithmetic operations on scalar values, for example, addition, subtraction, multiplication, division, and the like. The vector and scalar units may be pipelined to improve performance.

Image processing computations may involve heavy interaction between vector and scalar units. Because the prior art implements vector and scalar units that can be independently issued to, and having their own respective register files, transferring data between the units is usually very inefficient. For example, a scalar unit may load data from memory into its associated register file to perform a scalar operation. The results of the calculation may then be stored back in memory from the register file associated with the scalar unit. Subsequently, the results of the scalar operation stored in memory may be loaded into a separate register file associated with a vector unit to perform a vector operation.

The transfer of data to and from memory to transfer the data between scalar and vector units, and the dependencies between instructions may introduce significant delays that slow down processing of images, thereby adversely affecting the ability to render realistic images and animation. Embodiments of the invention combine the vector and scalar units into a single unit capable of performing both vector and scalar operations. Embodiments also provide a register file capable of storing both vector and scalar data.

### Exemplary System

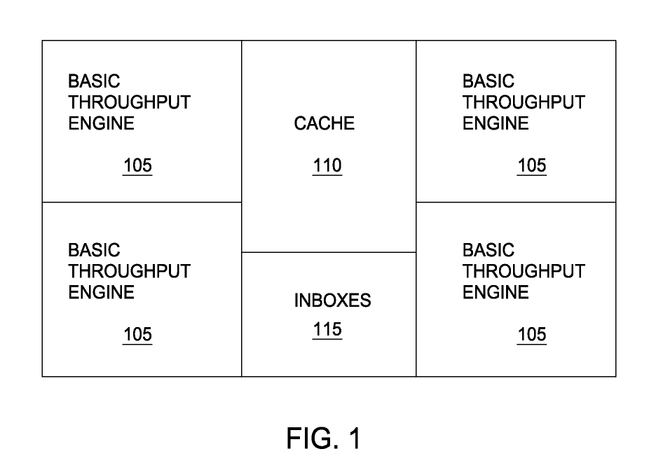

FIG. 1 illustrates an exemplary multiple core processing element 100, in which embodiments of the invention may be implemented. The multiple core processing element 100 includes a plurality of basic throughput engines 105 (BTEs). A BTE 105 may contain a plurality of processing threads and a core cache (e.g., an L1 cache). The processing threads located within each BTE may have access to a shared multiple core processing element cache 110 (e.g., an L2 cache).

The BTEs 105 may also have access to a plurality of inboxes 115. The inboxes 115 may be a memory mapped address space. The inboxes 115 may be mapped to the processing threads located within each of the BTEs 105. Each thread located within the BTEs may have a memory mapped inbox and access to all of the other memory mapped inboxes 115. The inboxes 115 make up a low latency and high bandwidth communications network used by the BTEs 105.

The BTEs may use the inboxes 115 as a network to communicate with each other and redistribute data processing work amongst the BTEs. For some embodiments, separate outboxes may be used in the communications network, for example, to receive the results of processing by BTEs 105. For other embodiments, inboxes 115 may also serve as outboxes, for example, with one BTE 105 writing the results of a processing function directly to the inbox of another BTE 105 that will use the results.

The aggregate performance of an image processing system may be tied to how well the BTEs can partition and redistribute work. The network of inboxes 115 may be used to collect and distribute work to other BTEs without corrupting the shared multiple core processing element cache 110 with BTE communication data packets that have no frame to frame coherency. An image processing system which can render many millions of triangles per frame may include many BTEs 105 connected in this manner.

In one embodiment of the invention, the threads of one BTE 105 may be assigned to a workload manager. An image processing system may use various software and hardware components to render a two-dimensional image from a three-dimensional scene. According to one embodiment of the invention, an image processing system may use a workload manager to traverse a spatial index with a ray issued by the image processing system. A spatial index may be implemented as a tree type data structure used to partition a relatively large three-dimensional scene into smaller bounding volumes. An image processing system using a ray tracing methodology for image processing may use a spatial index to quickly determine ray-bounding volume intersections. In one embodiment of the invention, the workload manager may perform ray-bounding volume intersection tests by using the spatial index.

In one embodiment of the invention, other threads of the multiple core processing element BTEs 105 on the multiple core processing element 100 may be vector throughput engines. After a workload manager determines a ray-bounding volume intersection, the workload manager may issue (send), via the inboxes 115, the ray to one of a plurality of vector throughput engines. The vector throughput engines may then determine if the ray intersects a primitive contained within the bounding volume. The vector throughput engines may also perform operations relating to determining the color of the pixel through which the ray passed.

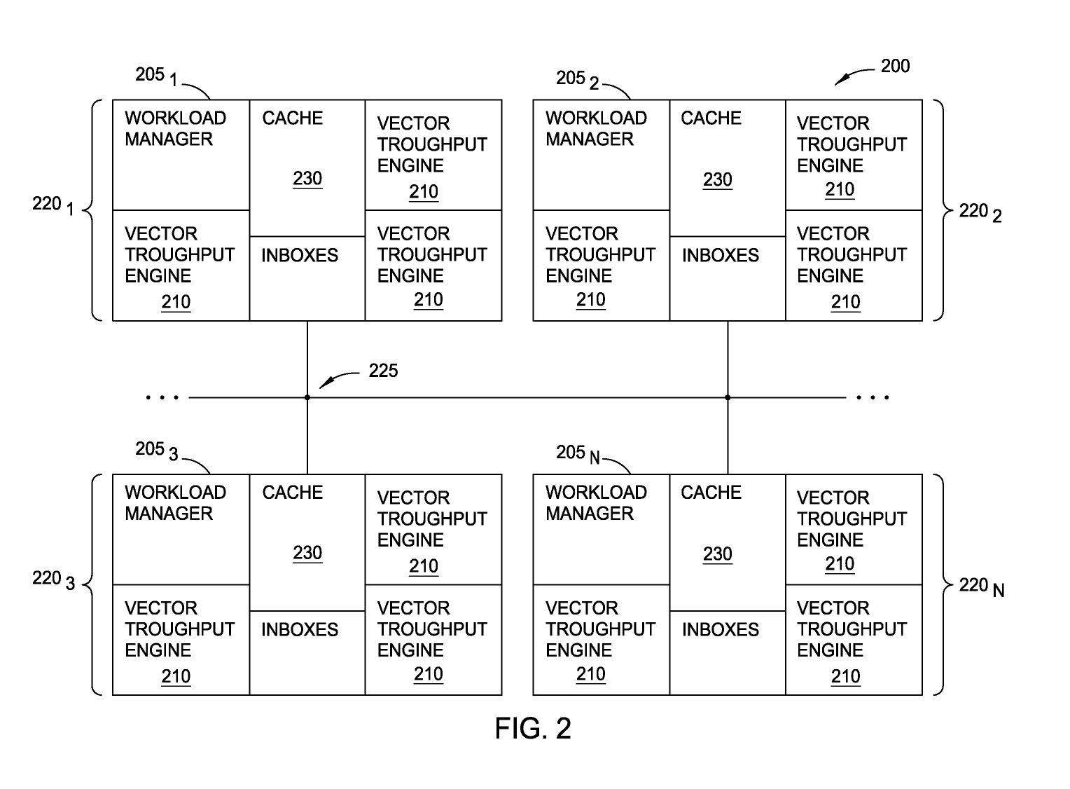

FIG. 2 illustrates a network of multiple core processing elements 200, according to one embodiment of the invention. FIG. 2 also illustrates one embodiment of the invention where the threads of one of the BTEs of the multiple core processing element 100 is a workload manager 205. Each multiple core processing element 220_{1-N} in the network of multiple core processing elements 200 may contain one workload manager 205_{1-N}, according to one embodiment of the invention. Each processor 220 in the network of multiple core processing elements 200 may also contain a plurality of vector throughput engines 210, according to one embodiment of the invention.

The workload managers 220_{1-N} may use a high speed bus 225 to communicate with other workload managers 220_{1-N} and/or vector throughput engines 210 of other multiple core processing elements 220, according to one embodiment of the invention. Each of the vector throughput engines 210 may use the high speed bus 225 to communicate with other vector throughput engines 210 or the workload managers 205. The workload manager processors 205 may use the high speed bus 225 to collect and distribute image processing related tasks to other workload manager processors 205, and/or distribute tasks to other vector throughput engines 210. The use of a high speed bus 225 may allow the workload managers 205_{1-N} to communicate without affecting the caches 230 with data packets related to workload manager 205 communications.

### An Exemplary Three-Dimensional Scene

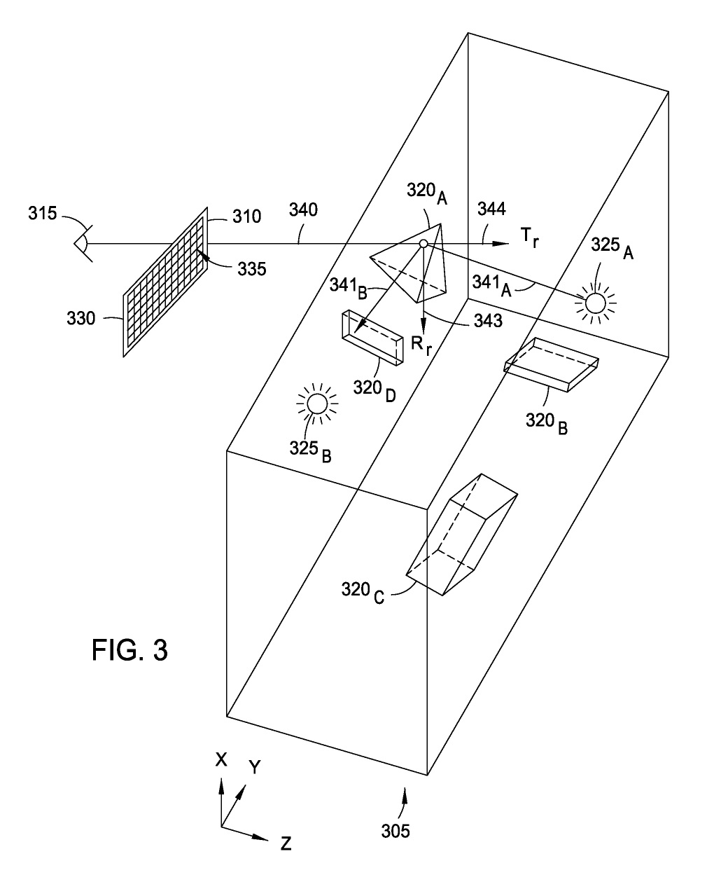

FIG. 3 is an exemplary three-dimensional scene 305 to be rendered by an image processing system. Within the three-dimensional scene 305 may be objects 320. The objects 320 in FIG. 3 are of different geometric shapes. Although only four objects 320 are illustrated in FIG. 3, the number of objects in a typical three-dimensional scene may be more or less. Commonly, three-dimensional scenes will have many more objects than illustrated in FIG. 3.

As can be seen in FIG. 3 the objects are of varying geometric shape and size. For example, one object in FIG. 3 is a pyramid 320_{A}. Other objects in FIG. 3 are boxes 320_{B-D}. In many modern image processing systems objects are often broken up into smaller geometric shapes (e.g., squares, circles, triangles, etc.). The larger objects are then represented by a number of the smaller simple geometric shapes. These smaller geometric shapes are often referred to as primitives.

Also illustrated in the scene 305 are light sources 325_{A-B}. The light sources may illuminate the objects 320 located within the scene 305. Furthermore, depending on the location of the light sources 325 and the objects 320 within the scene 305, the light sources may cause shadows to be cast onto objects within the scene 305.

The three-dimensional scene 305 may be rendered into a two-dimensional picture by an image processing system. The image processing system may also cause the two-dimensional picture to be displayed on a monitor 310. The monitor 310 may use many pixels 330 of different colors to render the final two-dimensional picture.

One method used by image processing systems to render a three-dimensional scene 320 into a two-dimensional picture is called ray tracing. Ray tracing is accomplished by the image processing system “issuing” or “shooting” rays from the perspective of a viewer 315 into the three-dimensional scene 320. The rays have properties and behavior similar to light rays.

One ray 340, that originates at the position of the viewer 315 and traverses through the three-dimensional scene 305, can be seen in FIG. 3. As the ray 340 traverses from the viewer 315 to the three-dimensional scene 305, the ray 340 passes through a plane where the final two-dimensional picture will be rendered by the image processing system. In FIG. 3 this plane is represented by the monitor 310. The point the ray 340 passes through the plane, or monitor 310, is represented by a pixel 335.

As briefly discussed earlier, most image processing systems use a grid 330 of thousands (if not millions) of pixels to render the final scene on the monitor 310. Each individual pixel may display a different color to render the final composite two-dimensional picture on the monitor 310. An image processing system using a ray tracing image processing methodology to render a two-dimensional picture from a three-dimensional scene will calculate the colors that the issued ray or rays encounters in the three-dimensional scene. The image processing scene will then assign the colors encountered by the ray to the pixel through which the ray passed on its way from the viewer to the three-dimensional scene.

The number of rays issued per pixel may vary. Some pixels may have many rays issued for a particular scene to be rendered. In which case the final color of the pixel is determined by the each color contribution from all of the rays that were issued for the pixel. Other pixels may only have a single ray issued to determine the resulting color of the pixel in the two-dimensional picture. Some pixels may not have any rays issued by the image processing system, in which case their color may be determined, approximated or assigned by algorithms within the image processing system.

To determine the final color of the pixel 335 in the two-dimensional picture, the image processing system must determine if the ray 340 intersects an object within the scene. If the ray does not intersect an object within the scene it may be assigned a default background color (e.g., blue or black, representing the day or night sky). Conversely, as the ray 340 traverses through the three-dimensional scene the ray 340 may strike objects. As the rays strike objects within the scene the color of the object may be assigned the pixel through which the ray passes. However, the color of the object must be determined before it is assigned to the pixel.

Many factors may contribute to the color of the object struck by the original ray 340. For example, light sources within the three-dimensional scene may illuminate the object. Furthermore, physical properties of the object may contribute to the color of the object. For example, if the object is reflective or transparent, other non-light source objects may then contribute to the color of the object.

In order to determine the effects from other objects within the three-dimensional scene, secondary rays may be issued from the point where the original ray 340 intersected the object. For example, one type of secondary ray may be a shadow ray. A shadow ray may be used to determine the contribution of light to the point where the original ray 340 intersected the object. Another type of secondary ray may be a transmitted ray. A transmitted ray may be used to determine what color or light may be transmitted through the body of the object. Furthermore, a third type of secondary ray may be a reflected ray. A reflected ray may be used to determine what color or light is reflected onto the object.

As noted above, one type of secondary ray may be a shadow ray. Each shadow ray may be traced from the point of intersection of the original ray and the object, to a light source within the three-dimensional scene 305. If the ray reaches the light source without encountering another object before the ray reaches the light source, then the light source will illuminate the object struck by the original ray at the point where the original ray struck the object.

For example, shadow ray 341_{A} may be issued from the point where original ray 340 intersected the object 320_{A}, and may traverse in a direction towards the light source 325_{A}. The shadow ray 341_{A} reaches the light source 325_{A} without encountering any other objects 320 within the scene 305. Therefore, the light source 325_{A} will illuminate the object 320_{A} at the point where the original ray 340 intersected the object 320_{A}.

Other shadow rays may have their path between the point where the original ray struck the object and the light source blocked by another object within the three-dimensional scene. If the object obstructing the path between the point on the object the original ray struck and the light source is opaque, then the light source will not illuminate the object at the point where the original ray struck the object. Thus, the light source may not contribute to the color of the original ray and consequently neither to the color of the pixel to be rendered in the two-dimensional picture. However, if the object is translucent or transparent, then the light source may illuminate the object at the point where the original ray struck the object.

For example, shadow ray 341_{B} may be issued from the point where the original ray 340 intersected with the object 320_{A}, and may traverse in a direction towards the light source 325_{B}. In this example, the path of the shadow ray 341_{B} is blocked by an object 320_{D}. If the object 320_{D} is opaque, then the light source 325_{B} will not illuminate the object 320_{A} at the point where the original ray 340 intersected the object 320_{A}. However, if the object 320_{D} which the shadow ray is translucent or transparent the light source 325_{B} may illuminate the object 320_{A} at the point where the original ray 340 intersected the object 320_{A}.

Another type of secondary ray is a transmitted ray. A transmitted ray may be issued by the image processing system if the object with which the original ray intersected has transparent or translucent properties (e.g., glass). A transmitted ray traverses through the object at an angle relative to the angle at which the original ray struck the object. For example, transmitted ray 344 is seen traversing through the object 320_{A} which the original ray 340 intersected.

Another type of secondary ray is a reflected ray. If the object with which the original ray intersected has reflective properties (e.g., a metal finish), then a reflected ray will be issued by the image processing system to determine what color or light may be reflected by the object. Reflected rays traverse away from the object at an angle relative to the angle at which the original ray intersected the object. For example, reflected ray 343 may be issued by the image processing system to determine what color or light may be reflected by the object 320_{A} which the original ray 340 intersected.

The total contribution of color and light of all secondary rays (e.g., shadow rays, transmitted rays, reflected rays, etc.) will result in the final color of the pixel through which the original ray passed.

### Vector Operations

Processing images may involve performing one or more vector operations to determine, for example, intersection of rays and objects, generation of shadow rays, reflected rays, and the like. One common operation performed during image processing is the cross product operation between two vectors. A cross product may be performed to determine a normal vector from a surface, for example, the surface of a primitive of an object in a three-dimensional scene. The normal vector may indicate whether the surface of the object is visible to a viewer.

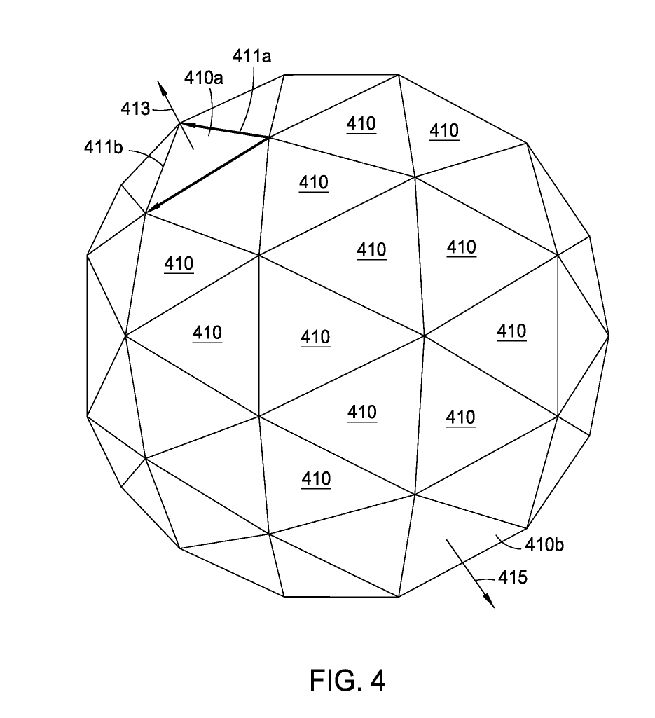

As previously described, each object in a scene may be represented as a plurality of primitives connected to one another to form the shape of the object. For example, in one embodiment, each object may be composed of a plurality of interconnected triangles. FIG. 4 illustrates an exemplary object 400 composed of a plurality of triangles 410. Object 400 may be a spherical object, formed by the plurality of triangles 410 in FIG. 4. For purposes of illustration a crude spherical object is shown. One skilled in the art will recognize that the surface of object 400 may be formed with a greater number of smaller triangles 410 to better approximate a curved object.

In one embodiment of the invention, the surface normal for each triangle 410 may be calculated to determine whether the surface of the triangle is visible to a viewer 450. To determine the surface normal for each triangle, a cross product operation may be performed between two vectors representing two sides of the triangle. For example, the surface normal 413 for triangle 410a may be computed by performing a cross product between vectors 411a and 411b.

The normal vector may determine whether a surface, for example, the surface of a primitive, faces a viewer. Referring to FIG. 4, normal vector 413 points in the direction of viewer 450. Therefore, triangle 410 may be displayed to the user. On the other hand, normal vector 415 of triangle 410b points away from viewer 450. Therefore, triangle 410b may not be displayed to the viewer.

### Ray-Volume Intersection Calculations

As discussed above, to determine the final color of the pixel in the two-dimensional picture, the image processing system must determine if a given ray intersects an object within the scene. For the sake of computational simplicity, the object may be considered to be bound by a volume that is simpler than the object itself. If a ray does not hit an object's bounding volume, then it will also miss the object itself.

If the bounding volume fits too loosely, then rays that would have missed the object may hit the bounding volume resulting in unnecessary calculations. If the bounding volume fits an object precisely, very few ray-object intersection calculations will be wasted. However, the ray-object intersection calculations may be significantly more complex.

Embodiments of the invention may utilize any suitably shaped bounding volume. For example, some embodiments may use parallelepipeds constructed of planes to bound the object. A general equation describing a plane in 3-space is illustrated in Equation 1.

Ax+By+Cz−d=0 (1)

The plane described by Equation 1 has a Normal Vector

$$N ≡ ( \begin{matrix}A \\ B \\ C\end{matrix} )$$

lying a distance d units from the origin. Further, there is a set of planes orthogonal to the Normal Vector N and parallel to each other, varying from one another only in the distance d from the origin. From this set, two planes may be chosen to bound a given object, where the region between the two planes is known as a slab.

The intersection of a set of bounding slabs yields a bounding volume. In order to create a closed bounding volume in 3-dimensional space, at least 2 sets of 3 bounding slabs must be utilized. Two points, w1 and w2, may be chosen to define each set of 3 slabs, each x, y or z component of which defines a plane and it's distance from the origin. This results in the two points (w1 and w2) defining a cube in 3-dimensional space.

A ray, where v(i) is a vector describing the direction of the ray and e(i) is a vector describing the offset of the eye point (i.e., the starting point of the ray) from the origin may intersect the bounding planes at an intersection point p. The magnitude of the ray from the eye point e(i) to the intersection point on the bounding planes may be calculated as shown in Equation 2. The magnitude of the ray, as calculated in Equation 2, may then be used to determine the intersection point p(i) of the ray with the bounding planes, as shown in Equation 3.

$$\begin{matrix}{t}_{1 , 2} ≡ \frac{{w}_{1 , 2} ( i ) - e ( i )}{v ( i )} & ( 2 ) \\ p ( i ) ≡ {v ( i )}^{*} t + e ( i ) & ( 3 )\end{matrix}$$

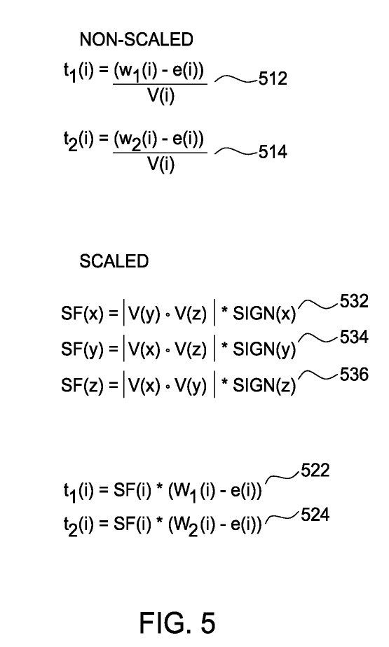

Similarly, FIG. 5 illustrates how the magnitude t of the ray from the eye point e(i) to the intersection point on the bounding planes may be calculated is computed for each set of bounding planes. As illustrated, there are two methods, a non-scaled and a scaled method, which may be utilized in calculating the intersection of a given ray and the two chosen bounding planes. Using the non-scaled method, the magnitude t₁(i) of the ray from e(i) to the first bounding plane is calculated as described by equation 512, where w₁(i) describes a first bounding plane, e(i) represents the offset of the ray from the origin, or origin-offset vector, and v(i) represents a normalized direction vector of the ray. Note that (i) represents the set (x, y, z) in Equation 512 and all subsequent equations. Similarly, the magnitude t₂(i) of the ray from e(i) to the second bounding plane is calculated as described by Equation 514, where w₂(i) describes the second plane. Once calculated, the magnitudes t₁(i) and magnitudes t₂(i) are compared. If t₁(i) is greater than t₂(i), the values are swapped (i.e., t₁(i) is assigned the value of t₂(i), and t₂(i) is assigned the old value of t₁(i)). This compensates for negative displacements of the ray from the origin. The values t₁(x), t₁(y), and t₁(z) are then compared and the greatest value may then be inserted into Equation 3, described above, to determine the first possible intersection point of the ray, pₙₑₐᵣ(i) with the bounding box. The values t₂(x), t₂(y), and t₂(z) are then compared and the smallest value may then be inserted into Equation 3, described above, to determine the second possible intersection point of the ray, p_{far}(i) with the bounding box. Lastly, the intersection points are evaluated to ensure the ray and bounding volume did, in fact, intersect.

Using the scaled method to calculate the intersection of the ray with the two bounding planes requires three steps. The first step is calculating scaling factors (SF) for the x, y and z components, as described by equations 532, 534, and 536, respectively. For example, the scaling factor for the x-component is calculated by multiplying the sign of the x-component of the direction vector v(i) with the absolute value of the dot product of the y-component and the z-component of the direction vector. Then the magnitude of the ray t₁(i) from e(i) to the first bounding plane w(i) is determined by multiplying the expression (w(i)−e(i)) by the scaling factors SF(i), as illustrated by equations 522. The same is repeated with the second bounding plane. Finally, as described above, the magnitudes t₁(i) and magnitudes t₂(i) are compared, if t₁(i) is greater than t₂(i), the values are swapped (i.e., t₁(i) is assigned the value of t₂(i), and t₂(i) is assigned the old value of t₁(x)). This compensates for negative displacements of the ray from the origin. t₁(x), t₁(y), and t₁(z) are then compared, the greatest value will then be inserted into Equation 3, described above, to determine the first possible intersection point of the ray, pₙₑₐᵣ(i) with the bounding box. t₂(x), t₂(y), and t₂(z) are then compared, the smallest value will then be inserted into Equation 3, described above, to determine the second possible intersection point of the ray, p_{far}(i) with the bounding box. Lastly, the intersection points are evaluated to ensure the ray and bounding volume did, in fact, intersect.

As illustrated above, the equations utilized in the non-scaled method involve a divide operation. Divide operations are typically complex and computationally expensive operations. The expense may be magnified by performing the divide operation for each of the three components of the vector. The expense may be magnified further by performing a ray-volume intersection test for each object a ray may encounter and for each ray cast (or spawned) to render a scene.

In contrast, employing a scaled method to determine the intersection of the ray and a bounding volume may avoid the use of a divide operation. Accordingly, system performance may be enhanced by performing ray-volume intersection tests using the scaled method.

As described above, a ray originates from an imaginary eye of a viewer, travels through a pixel on the screen, and through one or more objects within the scene. Further, the one or more objects may be bound by a corresponding number of volumes that may be mathematically simpler to describe than the object itself. As there are a number of pixels and a plurality of objects in a given scene, the number of intersections between rays and objects may be vast. At 602, a ray and a bounding volume are chosen and received by the processor.

At 604, the scaling factors SF(i) are calculated for the normalized direction vector v(i) of the ray, as described above. At 606, an intersection test is performed using the scaling factors SF(i) to determine if the ray intersects with the bounding volume of the selected object. As described above, to determine the final color of a pixel in a two-dimensional picture, the image processing system must determine if the ray intersects an object within the scene. As the rays strike objects within the scene the color of the object may be assigned the pixel through which the ray passes.

As noted above, if the bounding volume is chosen correctly, every ray that passes through the object will also pass through the bounding volume. Additionally, if the bounding volume is chosen correctly, few rays will pass through the bounding volume that do not pass through the object. Accordingly, the intersection point p(i) that results from the ray passing through the bounding volume may be used to determine the color of one or more pixels.

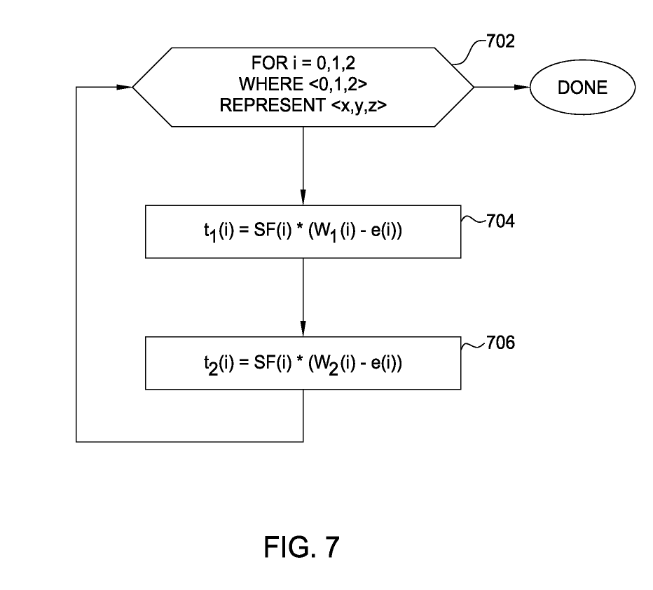

FIG. 7 further illustrates the steps involved in performing the intersection test. At 702, an evaluation is performed that determines if all coordinates have been evaluated. At 704, the magnitude of the ray from e(i) to the first bounding plane is calculated with respect to x. This is done by taking the difference of the x-component of the first bounding plane, represented by w₁(x), and the x-component of the offset vector, represented by e(x). This difference is then multiplied by the x-component of the scaling factor, represented by SF(x). At 706, the process is repeated; however, the x-coordinate of the second bounding plane, represented by w₂(x), is used. The process is repeated to determine the magnitude of the ray from e(i) to the bounding planes with respect to y and z.

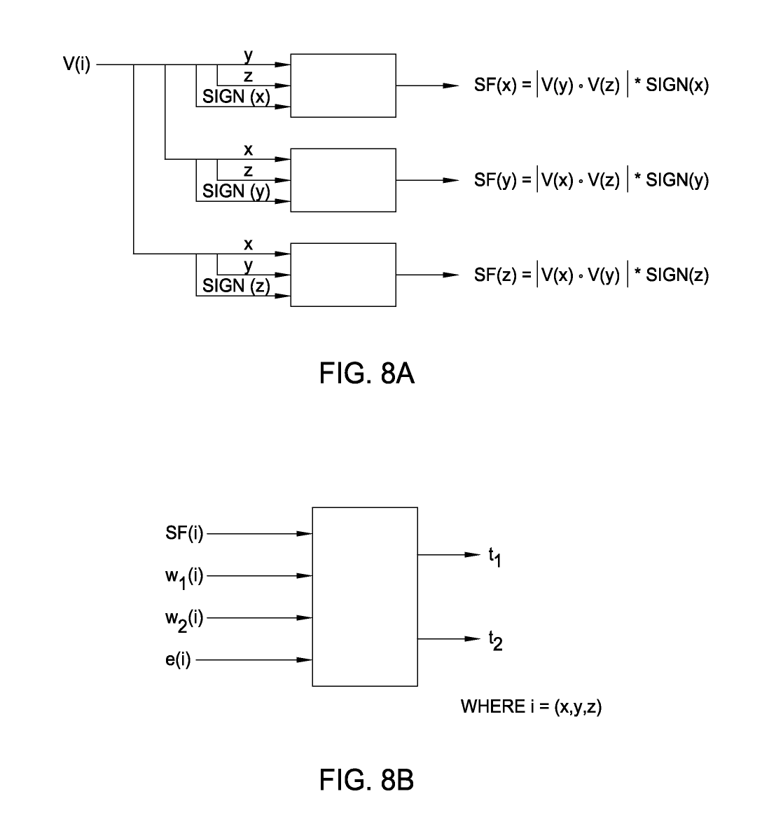

FIGS. 8A and 8B illustrates logic blocks depicting the scaled method of calculating the intersection of the ray with the two bounding planes. In FIG. 8A, scaling factors SF(i) are calculated from the normalized direction vector v(i). The scaling factors are then provided to the intersection test logic along with the bounding planes w(i) and the origin-offset vector e(i), as illustrated in FIG. 8B. Note that the logic illustrated in FIGS. 8A and 8B are often implemented in software; however, embodiments of the present invention may also use hardware to implement the illustrated logic.

### CONCLUSION

By employing the scaled method for calculating the intersection of a ray with two bounding planes, clock cycles may be saved when compared to a non-scaled approach. The improvement in ray-volume intersection calculation time may result in better performance, specifically in applications requiring complex image processing.

While the foregoing is directed to embodiments of the present invention, other and further embodiments of the invention may be devised without departing from the basic scope thereof, and the scope thereof is determined by the claims that follow.

What is claimed is:

1. A method for performing an intersection test for a ray and a bounding volume, comprising:
calculating scaling factors based on x, y and z component values of a direction vector defining the ray; and
utilizing the scaling factors to perform the intersection test without division operations.

2. The method of claim 1, wherein the direction vector comprises x, y and z components and calculating the scaling factors comprises:
calculating an x-component scaling factor based on they y and z components of the direction vector;
calculating a y-component scaling factor based on they x and z components of the direction vector; and
calculating a z-component scaling factor based on they x and y components of the direction vector.

3. The method of claim 1, wherein the ray is further defined by an offset from an origin and utilizing the scaling factors to perform the intersection test without division operations comprises:
calculating an x-coordinate for the intersection between the ray and a first face of the bounding volume based on the x-component scaling factor;
calculating a y-coordinate for the intersection between the ray and a first face of the bounding volume based on the y-component scaling factor; and
calculating a z-coordinate for the intersection between the ray and a first face of the bounding volume based on the z-component scaling factor.

4. The method of claim 1, wherein the ray is further defined by an offset from an origin and utilizing the scaling factors to perform the intersection test without division operations comprises:
calculating an x-coordinate for the intersection between the ray and a second face of the bounding volume based on the x-component scaling factor;
calculating a y-coordinate for the intersection between the ray and a second face of the bounding volume based on the y-component scaling factor; and
calculating a z-coordinate for the intersection between the ray and a second face of the bounding volume based on the z-component scaling factor.

5. The method of claim 4, further comprising the calculated x, y and z-coordinates.

6. The method of claim 5, further comprising spawning one or more additional rays with an origin defined by the x, y and z-coordinates.

7. A processor capable of performing intersection tests for a ray and a bounding volume, comprising:
logic for calculating scaling factors based on x, y and z component values of a direction vector defining the ray; and
logic for utilizing the scaling factors to perform the intersection test without division operations.

8. The processor of claim 7, wherein the direction vector comprises x, y and z components and logic for calculating the scaling factors comprises:
logic for calculating an x-component scaling factor based on they y and z components of the direction vector;
logic for calculating a y-component scaling factor based on they x and z components of the direction vector; and
logic for calculating a z-component scaling factor based on they x and y components of the direction vector.

9. The processor of claim 7, wherein the ray is further defined by an offset from an origin and the logic for utilizing the scaling factors to perform the intersection test without division operations comprises:
logic for calculating an x-coordinate for the intersection between the ray and a first face of the bounding volume based on the x-component scaling factor;
logic for calculating a y-coordinate for the intersection between the ray and a first face of the bounding volume based on the y-component scaling factor; and
logic for calculating a z-coordinate for the intersection between the ray and a first face of the bounding volume based on the z-component scaling factor.

10. The processor of claim 7, wherein the ray is further defined by an offset from an origin and the logic for utilizing the scaling factors to perform the intersection test without division operations comprises:
logic for calculating an x-coordinate for the intersection between the ray and a second face of the bounding volume;
logic for calculating a y-coordinate for the intersection between the ray and a second face of the bounding volume; and
logic for calculating a z-coordinate for the intersection between the ray and a second face of the bounding volume.

11. The processor of claim 7, wherein logic for utilizing the scaling factors to perform the intersection test without division operations produce result values of the intersection test and the result values of the intersection test are stored in memory.

12. The processor of claim 7, wherein additional rays are spawned based on the results of the intersection test.

13. A system, configured to perform an intersection test for a ray and a bounding volume, comprising:
logic for calculating scaling factors based on x, y and z component values of a direction vector defining the ray; and
logic for utilizing the scaling factors to perform the intersection test without division operations.

14. The system of claim 13, wherein the direction vector comprises x, y and z components and the system is configured to calculate the scaling factors, comprising:
logic for calculating an x-component scaling factor based on they y and z components of the direction vector;
logic for calculating a y-component scaling factor based on they x and z components of the direction vector; and
logic for calculating a z-component scaling factor based on they x and y components of the direction vector.

15. The system of claim 13, wherein the ray is further defined by an offset from an origin and the logic for utilizing the scaling factors to perform the intersection test without division operations comprises:
logic for calculating an x-coordinate for the intersection between the ray and a first face of the bounding volume based on the x-component scaling factor;
logic for calculating a y-coordinate for the intersection between the ray and a first face of the bounding volume based on the y-component scaling factor; and
logic for calculating a z-coordinate for the intersection between the ray and a first face of the bounding volume based on the z-component scaling factor.

16. The system of claim 13, wherein the ray is further defined by an offset from an origin and the logic for utilizing the scaling factors to perform the intersection test without division operations comprises:
logic for calculating an x-coordinate for the intersection between the ray and a second face of the bounding volume based on the x-component scaling factor;
logic for calculating a y-coordinate for the intersection between the ray and a second face of the bounding volume based on the y-component scaling factor; and
logic for calculating a z-coordinate for the intersection between the ray and a second face of the bounding volume based on the z-component scaling factor.

17. The system of claim 13, wherein logic for utilizing the scaling factors to perform the intersection test without division operations produce result values of the intersection test and the result values of the intersection test are stored in memory.

18. The system of claim 13, wherein additional rays are spawned based on the results of the intersection test.
